(19) United States
(12) Patent Application Publication
(10) Pub. No.: US 2017/0011557 A1
(43) Pub. Date: Jan. 12, 2017

(54) METHOD FOR PROVIDING AUGMENTED REALITY AND VIRTUAL REALITY AND ELECTRONIC DEVICE USING THE SAME

(71) Applicant: Samsung Electronics Co., Ltd, Gyeonggi-do (KR)

(72) Inventors: Olivia Lee, Seoul (KR); Seungmyung Lee, Seoul (KR); Jueun Lee, Seoul (KR); James Powderly, Pembroke Pines, FL (US); Jinmi Choi, Seoul (KR)

(21) Appl. No.: 15/203,746

(22) Filed: Jul. 6, 2016

(30) Foreign Application Priority Data
Jul. 6, 2015 (KR) 10-2015-0095848

(51) Int. Cl. G06T 19/00; G06F 3/0482; G06F 3/0488; G06F 3/01; G06F 3/16

(52) U.S. Cl. CPC G06T 19/006; G06F 3/013; G06F 3/167; G06F 3/04883; G06F 3/0482

(57) ABSTRACT

In an embodiment, an electric device performs a method for outputting content. In this method, the electronic device detects a selection of content by a user and ascertains a reference factor corresponding to the content. Then the electronic device determines a display mode corresponding to the reference factor and outputs the content, based on the display mode. Other embodiments are possible.

### CROSS-REFERENCE TO RELATED APPLICATION(S) AND CLAIM OF PRIORITY

The present application is related to and claims benefit under 35 U.S.C. §119(a) of Korean patent application filed on Jul. 6, 2015 in the Korean Intellectual Property Office and assigned Serial number 10-2015-0095848, the entire disclosure of which is hereby incorporated by reference.

### TECHNICAL FIELD

Various embodiments of the present disclosure relate to a method for providing an integrated experience of augmented reality and virtual reality according to context and also relate to an electronic device using the method.

### BACKGROUND

Today, a smart glass may be classified into a device based on augmented reality (AR) capable of providing instant information, such as Google Glass®, and a device based on virtual reality (VR) capable of using immersive virtual reality content, such as Oculus.

A conventional smart glass provides only one technique of either AR or VR within a device. Namely, an AR-based device may not have the ability to provide VR since failing to block any situation (hereinafter referred to as context) in which an external environment is seen. Additionally, a VR-based device may not enter any context in which an external environment is seen. Therefore, a single device may have difficulty in providing both AR and VR.

Further, since a conventional smart glass adopts a sequential page transfer scheme as a control method, it has limitations in efficiently controlling whole environments thereof. For example, in an embodiment of intending to move from a currently activated page to a menu screen, there is no choice but to keep going backward step-by-step.

### SUMMARY

Various embodiments of the present disclosure may analyze context in an electronic device (e.g., smart glass) and then, based on the analyzed context, provide selectively or synthetically AR and VR. Also, various embodiments of the present disclosure may provide a non-sequential menu transfer method using eye tracking in an electronic device.

According to various embodiments of the present disclosure, a method for outputting content in an electronic device may include operations of detecting a selection of content by a user; ascertaining a reference factor corresponding to the content; determining a display mode corresponding to the reference factor; and outputting the content, based on the display mode.

According to various embodiments of the present disclosure, an electronic device may include a display; a communication module; a sensor module; a processor electrically connected to the display, the communication module, and the sensor module; and a memory electrically connected to the processor. In this device, the memory may store instructions which cause, when executed, the processor to detect a selection of content by a user, to ascertain a reference factor corresponding to the content, to determine a display mode corresponding to the reference factor, and to output the content, based on the display mode.

According to various embodiments of the present disclosure, the electronic device (e.g., smart glass) may analyze context and then offer selectively or synthetically AR and VR on the basis of the analyzed context. Further, by using eye tracking, the electronic device may provide a non-sequential menu transfer method.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network environment including an electronic device according to various embodiments of the present disclosure.

FIG. 2 illustrates an electronic device according to various embodiments of the present disclosure.

FIG. 3 illustrates a program module according to various embodiments of the present disclosure.

FIG. 4 illustrates a side view of an electronic device according to various embodiments of the present disclosure.

FIG. 5 illustrates a menu access method of an electronic device according to various embodiments of the present disclosure.

FIG. 6 illustrates a rotation of an electronic device according to various embodiments of the present disclosure.

FIG. 7 illustrates a method for changing objects by selecting one of objects in an electronic device according to various embodiments of the present disclosure.

FIG. 8 illustrates a non-linear object search method of an electronic device according to various embodiments of the present disclosure.

FIG. 9 illustrates a method for executing at least one object in an electronic device according to various embodiments of the present disclosure.

FIG. 10 illustrates a user interface for setting one of AR and VR in an electronic device according to various embodiments of the present disclosure.

FIG. 11 illustrates reference factors considered for selecting one of AR, VR, and MR by an electronic device according to various embodiments of the present disclosure.

FIG. 12 illustrates a method for providing weather information in an electronic device according to various embodiments of the present disclosure.

FIG. 13 illustrates a method for setting a display mode depending on a context analysis in an electronic device according to various embodiments of the present disclosure.

FIG. 14 illustrates a method for receiving an object provided in a specific area by an electronic device according to various embodiments of the present disclosure.

FIG. 15 illustrates a method for outputting an object provided in a specific area by an electronic device according to various embodiments of the present disclosure.

FIG. 16 illustrates a method for outputting different objects based on a head rotation of a user of an electronic device according to various embodiments of the present disclosure.

### DETAILED DESCRIPTION

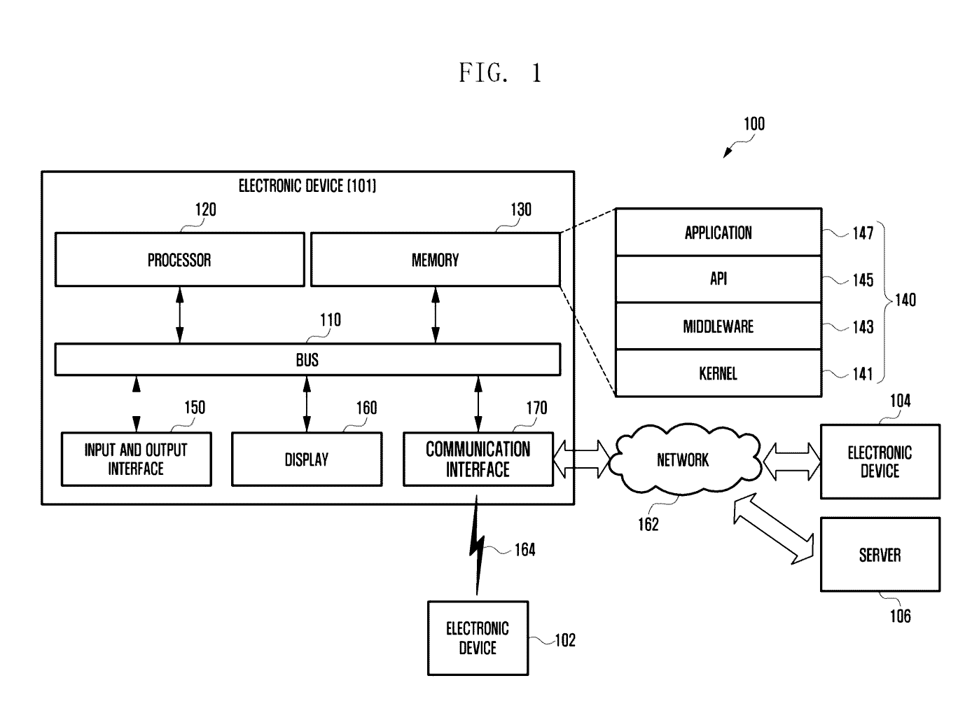

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Hereinafter, embodiments of the present disclosure are described in detail with reference to the accompanying drawings. While the present disclosure may be embodied in many different forms, specific embodiments of the present disclosure are shown in drawings and are described herein in detail, with the understanding that the present disclosure is to be considered as an exemplification of the principles of the disclosure and is not intended to limit the disclosure to the specific embodiments illustrated. The same reference numbers are used throughout the drawings to refer to the same or like parts.

An expression “comprising” or “may comprise” used in the present disclosure indicates presence of a corresponding function, operation, or element and does not limit additional at least one function, operation, or element. Further, in the present disclosure, a term “comprise” or “have” indicates presence of a characteristic, numeral, step, operation, element, component, or combination thereof described in a specification and does not exclude presence or addition of at least one other characteristic, numeral, step, operation, element, component, or combination thereof.

In the present disclosure, an expression “or” includes any combination or the entire combination of together listed words. For example, “A or B” may include A, B, or A and B.

An expression of a first and a second in the present disclosure may represent various elements of the present disclosure, but do not limit corresponding elements. For example, the expression does not limit order and/or importance of corresponding elements. The expression may be used for distinguishing one element from another element. For example, both a first user device and a second user device are user devices and represent different user devices. For example, a first constituent element may be referred to as a second constituent element without deviating from the scope of the present disclosure, and similarly, a second constituent element may be referred to as a first constituent element.

When it is described that an element is “coupled” to another element, the element may be “directly coupled” to the other element or “electrically coupled” to the other element through a third element. However, when it is described that an element is “directly coupled” to another element, no element may exist between the element and the other element.

Terms used in the present disclosure are not to limit the present disclosure but to illustrate various non-limiting, exemplary embodiments. When using in a description of the present disclosure and the appended claims, a singular form includes a plurality of forms unless it is explicitly differently represented.

Unless differently defined, entire terms including a technical term and a scientific term used here have the same meaning as a meaning that may be generally understood by a person of common skill in the art. It should be analyzed that generally using terms defined in a dictionary have a meaning corresponding to that of a context of related technology and are not analyzed as an ideal or excessively formal meaning unless explicitly defined.

In this disclosure, an electronic device may be a device that involves a communication function. For example, an electronic device may be a smart phone, a tablet PC (Personal Computer), a mobile phone, a video phone, an e-book reader, a desktop PC, a laptop PC, a netbook computer, a PDA (Personal Digital Assistant), a PMP (Portable Multimedia Player), an MP3 player, a portable medical device, a digital camera, or a wearable device (e.g., an HMD (Head-Mounted Device) such as electronic glasses, electronic clothes, an electronic bracelet, an electronic necklace, an electronic appcessory, or a smart watch).

According to some embodiments, an electronic device may be a smart home appliance that involves a communication function. For example, an electronic device may be a TV, a DVD (Digital Video Disk) player, audio equipment, a refrigerator, an air conditioner, a vacuum cleaner, an oven, a microwave, a washing machine, an air cleaner, a set-top box, a TV box (e.g., Samsung HomeSync®, Apple TV®, Google TV®, etc.), a game console, an electronic dictionary, an electronic key, a camcorder, or an electronic picture frame.

According to some embodiments, an electronic device may be a medical device (e.g., MRA (Magnetic Resonance Angiography), MM (Magnetic Resonance Imaging), CT (Computed Tomography), ultrasonography, etc.), a navigation device, a GPS (Global Positioning System) receiver, an EDR (Event Data Recorder), an FDR (Flight Data Recorder), a car infotainment device, electronic equipment for ship (e.g., a marine navigation system, a gyrocompass, etc.), avionics, security equipment, or an industrial or home robot.

According to some embodiments, an electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof. As well understood by those skilled in the art, the above-mentioned electronic devices are exemplary only and not to be considered as a limitation of this disclosure.

FIG. 1 is a block diagram 100 illustrating an electronic apparatus according to an embodiment of the present disclosure.

Referring to FIG. 1, the electronic apparatus 101 may include a bus 110, a processor 120, a memory 130, a user input module 150, a display 160, and a communication interface 170.

The bus 110 may be a circuit for interconnecting elements described above and for allowing a communication, e.g. by transferring a control message, between the elements described above.

The processor 120 can receive commands from the above-mentioned other elements, e.g. the memory 130, the user input module 150, the display 160, and the communication interface 170, through, for example, the bus 110, can decipher the received commands, and perform operations and/or data processing according to the deciphered commands.

The memory 130 can store commands received from the processor 120 and/or other elements, e.g. the user input module 150, the display 160, and the communication interface 170, and/or commands and/or data generated by the processor 120 and/or other elements. The memory 130 may include softwares and/or programs 140, such as a kernel 141, middleware 143, an Application Programming Interface (API) 145, and an application 147. Each of the programming modules described above may be configured by software, firmware, hardware, and/or combinations of two or more thereof.

The kernel 141 can control and/or manage system resources, e.g. the bus 110, the processor 120 or the memory 130, used for execution of operations and/or functions implemented in other programming modules, such as the middleware 143, the API 145, and/or the application 147. Further, the kernel 141 can provide an interface through which the middleware 143, the API 145, and/or the application 147 can access and then control and/or manage an individual element of the electronic apparatus 100.

The middleware 143 can perform a relay function which allows the API 145 and/or the application 147 to communicate with and exchange data with the kernel 141. Further, in relation to operation requests received from at least one of an application 147, the middleware 143 can perform load balancing in relation to the operation requests by, for example, giving a priority in using a system resource, e.g. the bus 110, the processor 120, and/or the memory 130, of the electronic apparatus 100 to at least one application from among the at least one of the application 147.

The API 145 is an interface through which the application 147 can control a function provided by the kernel 141 and/or the middleware 143, and may include, for example, at least one interface or function for file control, window control, image processing, and/or character control.

The user input module 150 can receive, for example, a command and/or data from a user, and transfer the received command and/or data to the processor 120 and/or the memory 130 through the bus 110. The display 160 can display an image, a video, and/or data to a user.

The communication interface 170 can establish a communication between the electronic apparatus 100 and another electronic devices 102 and 104 and/or a server 164. The communication interface 170 can support short range communication protocols, e.g. a Wireless Fidelity (WiFi) protocol, a BlueTooth® (BT) protocol, and a Near Field Communication (NFC) protocol, communication networks, e.g. Internet, Local Area Network (LAN), Wire Area Network (WAN), a telecommunication network, a cellular network, and a satellite network, or a Plain Old Telephone Service (POTS), or any other similar and/or suitable communication networks, such as network 162, or the like. Each of the electronic devices 102 and 104 may be a same type and/or different types of electronic apparatus.

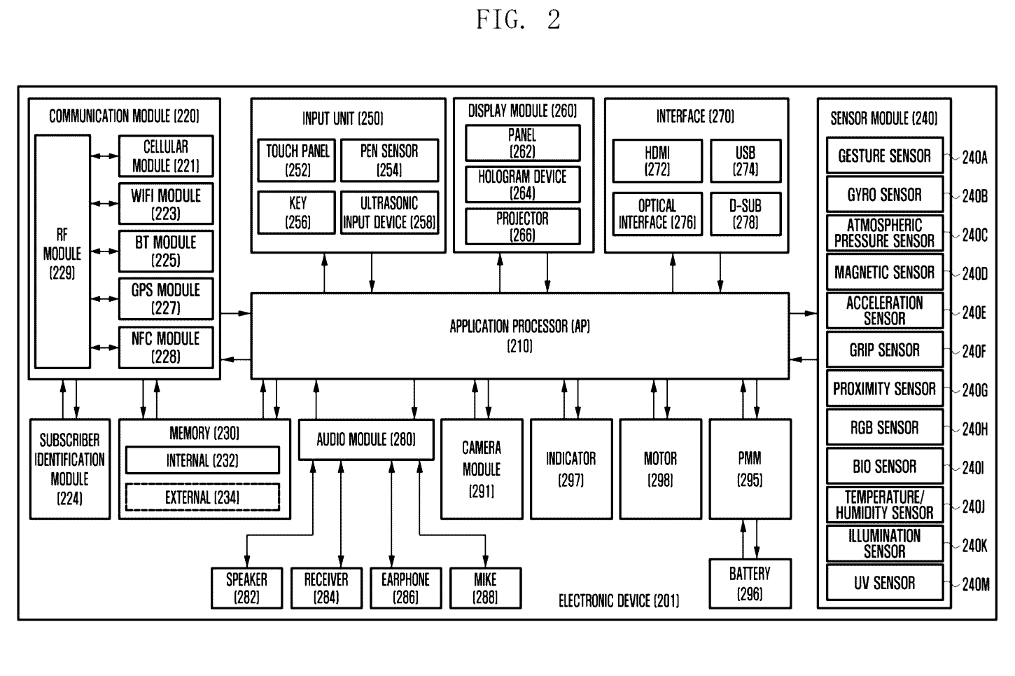

FIG. 2 is a block diagram illustrating an electronic device 201 in accordance with an embodiment of the present disclosure. The electronic device 201 may form, for example, the whole or part of the electronic device 101 shown in FIG. 1. Referring to FIG. 2, the electronic device 201 may include at least one application processor (AP) 210, a communication module 220, a subscriber identification module (SIM) card 224, a memory 230, a sensor module 240, an input unit 250, a display 260, an interface 270, an audio module 280, a camera module 291, a power management module 295, a battery 296, an indicator 297, and a motor 298.

The AP 210 may drive an operating system or applications, control a plurality of hardware or software components connected thereto, and also perform processing and operation for various data including multimedia data. The AP 210 may be formed of system-on-chip (SoC), for example. According to an embodiment, the AP 210 may further include a graphic processing unit (GPU) (not shown).

The communication module 220 (e.g., the communication interface 160) may perform a data communication with any other electronic device (e.g., the electronic device 104 or the server 106) connected to the electronic device 200 (e.g., the electronic device 101) through the network. According to an embodiment, the communication module 220 may include therein a cellular module 221, a WiFi module 223, a BT module 225, a GPS module 227, an NFC module 228, and an RF (Radio Frequency) module 229.

The cellular module 221 may offer a voice call, a video call, a message service, an internet service, or the like through a communication network (e.g., LTE, LTE-A, CDMA, WCDMA, UMTS, WiBro, or GSM, etc.). Additionally, the cellular module 221 may perform identification and authentication of the electronic device in the communication network, using the SIM card 224. According to an embodiment, the cellular module 221 may perform at least part of functions the AP 210 can provide. For example, the cellular module 221 may perform at least part of a multimedia control function.

According to an embodiment, the cellular module 221 may include a communication processor (CP). Additionally, the cellular module 221 may be formed of SoC, for example. Although some elements such as the cellular module 221 (e.g., the CP), the memory 230, or the power management module 295 are shown as separate elements being different from the AP 210 in FIG. 2, the AP 210 may be formed to have at least part (e.g., the cellular module 221) of the above elements in an embodiment.

According to an embodiment, the AP 210 or the cellular module 221 (e.g., the CP) may load commands or data, received from a nonvolatile memory connected thereto or from at least one of the other elements, into a volatile memory to process them. Additionally, the AP 210 or the cellular module 221 may store data, received from or created at one or more of the other elements, in the nonvolatile memory.

Each of the WiFi module 223, the BT module 225, the GPS module 227 and the NFC module 228 may include a processor for processing data transmitted or received therethrough. Although FIG. 2 shows the cellular module 221, the WiFi module 223, the BT module 225, the GPS module 227 and the NFC module 228 as different blocks, at least part of them may be contained in a single IC (Integrated Circuit) chip or a single IC package in an embodiment. For example, at least part (e.g., the CP corresponding to the cellular module 221 and a WiFi processor corresponding to the WiFi module 223) of respective processors corresponding to the cellular module 221, the WiFi module 223, the BT module 225, the GPS module 227 and the NFC module 228 may be formed as a single SoC.

The RF module 229 may transmit and receive data, e.g., RF signals or any other electric signals. Although not shown, the RF module 229 may include a transceiver, a PAM (Power Amp Module), a frequency filter, an LNA (Low Noise Amplifier), or the like. Also, the RF module 229 may include any component, e.g., a wire or a conductor, for transmission of electromagnetic waves in a free air space. Although FIG. 2 shows that the cellular module 221, the WiFi module 223, the BT module 225, the GPS module 227 and the NFC module 228 share the RF module 229, at least one of them may perform transmission and reception of RF signals through a separate RF module in an embodiment.

The SIM card 224_1 to 224_N may be a specific card formed of SIM and may be inserted into a slot 225_1 to 225_N formed at a certain place of the electronic device. The SIM card 224_1 to 224_N may contain therein an ICCID (Integrated Circuit Card IDentifier) or an IMSI (International Mobile Subscriber Identity).

The memory 230 (e.g., the memory 130) may include an internal memory 232 and an external memory 234. The internal memory 232 may include, for example, at least one of a volatile memory (e.g., DRAM (Dynamic RAM), SRAM (Static RAM), SDRAM (Synchronous DRAM), etc.) or a nonvolatile memory (e.g., OTPROM (One Time Programmable ROM), PROM (Programmable ROM), EPROM (Erasable and Programmable ROM), EEPROM (Electrically Erasable and Programmable ROM), mask ROM, flash ROM, NAND flash memory, NOR flash memory, etc.).

According to an embodiment, the internal memory 232 may have the form of an SSD (Solid State Drive). The external memory 234 may include a flash drive, e.g., CF (Compact Flash), SD (Secure Digital), Micro-SD (Micro Secure Digital), Mini-SD (Mini Secure Digital), xD (eXtreme Digital), memory stick, or the like. The external memory 234 may be functionally connected to the electronic device 200 through various interfaces. According to an embodiment, the electronic device 200 may further include a storage device or medium such as a hard drive.

The sensor module 240 may measure physical quantity or sense an operating status of the electronic device 200, and then convert measured or sensed information into electric signals. The sensor module 240 may include, for example, at least one of a gesture sensor 240A, a gyro sensor 240B, an atmospheric sensor 240C, a magnetic sensor 240D, an acceleration sensor 240E, a grip sensor 240F, a proximity sensor 240G, a color sensor 240H (e.g., RGB (Red, Green, Blue) sensor), a biometric sensor 240I, a temperature-humidity sensor 240J, an illumination sensor 240K, and a UV (ultraviolet) sensor 240M. Additionally or alternatively, the sensor module 240 may include, e.g., an E-nose sensor (not shown), an EMG (electromyography) sensor (not shown), an EEG (electroencephalogram) sensor (not shown), an ECG (electrocardiogram) sensor (not shown), an IR (infrared) sensor (not shown), an iris scan sensor (not shown), or a finger scan sensor (not shown). Also, the sensor module 240 may include a control circuit for controlling one or more sensors equipped therein.

The input unit 250 may include a touch panel 252, a digital pen sensor 254, a key 256, or an ultrasonic input unit 258. The touch panel 252 may recognize a touch input in a manner of capacitive type, resistive type, infrared type, or ultrasonic type. Also, the touch panel 252 may further include a control circuit. In an embodiment including a capacitive type, a physical contact or proximity may be recognized. The touch panel 252 may further include a tactile layer. In this example, the touch panel 252 may offer a tactile feedback to a user.

The digital pen sensor 254 may be formed in the same or similar manner as receiving a touch input or by using a separate recognition sheet. The key 256 may include, for example, a physical button, an optical key, or a keypad. The ultrasonic input unit 258 is a specific device capable of identifying data by sensing sound waves with a microphone 288 in the electronic device 200 through an input tool that generates ultrasonic signals, thus allowing wireless recognition. According to an embodiment, the electronic device 200 may receive a user input from any external device (e.g., a computer or a server) connected thereto through the communication module 220.

The display 260 (e.g., the display 150) may include a panel 262, a hologram 264, or a projector 266. The panel 262 may be, for example, LCD (Liquid Crystal Display), AM-OLED (Active Matrix Organic Light Emitting Diode), or the like. The panel 262 may have a flexible, transparent or wearable form. The panel 262 may be formed of a single module with the touch panel 252. The hologram 264 may show a stereoscopic image in the air using interference of light. The projector 266 may project an image onto a screen, which may be located at the inside or outside of the electronic device 200. According to an embodiment, the display 260 may further include a control circuit for controlling the panel 262, the hologram 264, and the projector 266.

The interface 270 may include, for example, an HDMI (High-Definition Multimedia Interface) 272, a USB (Universal Serial Bus) 274, an optical interface 276, or a D-sub (D-subminiature) 278. The interface 270 may be contained, for example, in the communication interface 160 shown in FIG. 1. Additionally or alternatively, the interface 270 may include, for example, an MHL (Mobile High-definition Link) interface, an SD (Secure Digital) card/MMC (Multi-Media Card) interface, or an IrDA (Infrared Data Association) interface.

The audio module 280 may perform a conversion between sounds and electric signals. At least part of the audio module 280 may be contained, for example, in the input/output interface 140 shown in FIG. 1. The audio module 280 may process sound information inputted or outputted through a speaker 282, a receiver 284, an earphone 286, or a microphone 288.

The camera module 291 is a device capable of obtaining still images and moving images. According to an embodiment, the camera module 291 may include at least one image sensor (e.g., a front sensor or a rear sensor), a lens (not shown), an ISP (Image Signal Processor, not shown), or a flash (e.g., LED or xenon lamp, not shown).

The power management module 295 may manage electric power of the electronic device 200. Although not shown, the power management module 295 may include, for example, a PMIC (Power Management Integrated Circuit), a charger IC, or a battery or fuel gauge.

The PMIC may be formed, for example, of an IC chip or SoC. Charging may be performed in a wired or wireless manner. The charger IC may charge a battery 296 and prevent overvoltage or overcurrent from a charger. According to an embodiment, the charger IC may have a charger IC used for at least one of wired and wireless charging types. A wireless charging type may include, for example, a magnetic resonance type, a magnetic induction type, or an electromagnetic type. Any additional circuit for a wireless charging may be further used such as a coil loop, a resonance circuit, or a rectifier.

The battery gauge may measure the residual amount of the battery 296 and a voltage, current or temperature in a charging process. The battery 296 may store or create electric power therein and supply electric power to the electronic device 200. The battery 296 may be, for example, a rechargeable battery or a solar battery.

The indicator 297 may show thereon a current status (e.g., a booting status, a message status, or a recharging status) of the electronic device 200 or of its part (e.g., the AP 210). The motor 298 may convert an electric signal into a mechanical vibration. Although not shown, the electronic device 200 may include a specific processor (e.g., GPU) for supporting a mobile TV. This processor may process media data that comply with standards of DMB (Digital Multimedia Broadcasting), DVB (Digital Video Broadcasting), or media flow.

Each of the above-discussed elements of the electronic device disclosed herein may be formed of one or more components, and its name may be varied according to the type of the electronic device. The electronic device disclosed herein may be formed of at least one of the above-discussed elements without some elements or with additional other elements. Some of the elements may be integrated into a single entity that still performs the same functions as those of such elements before integrated.

The term “module” used in this disclosure may refer to a certain unit that includes one of hardware, software and firmware or any combination thereof. The module may be interchangeably used with unit, logic, logical block, component, or circuit, for example. The module may be the minimum unit, or part thereof, which performs one or more particular functions. The module may be formed mechanically or electronically. For example, the module disclosed herein may include at least one of ASIC (Application-Specific Integrated Circuit) chip, FPGAs (Field-Programmable Gate Arrays), and programmable-logic device, which have been known or are to be developed.

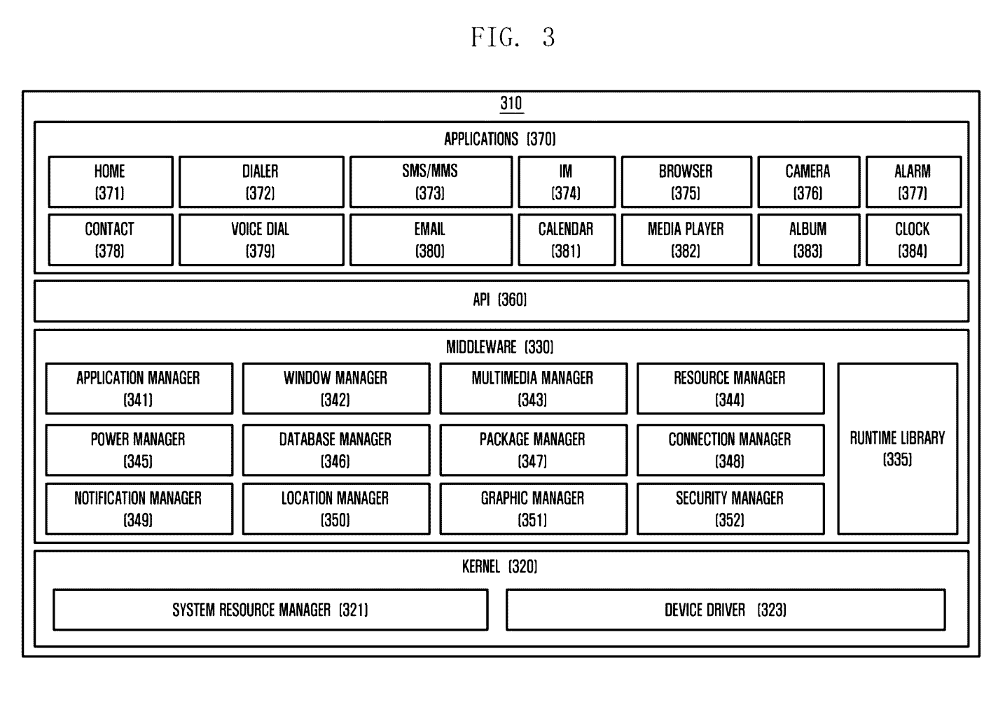

FIG. 3 is a block diagram illustrating a configuration of a programming module 300 according to an embodiment of the present disclosure.

The programming module 300 may be included (or stored) in the electronic device 100 (e.g., the memory 130) or may be included (or stored) in the electronic device 200 (e.g., the memory 230) illustrated in FIG. 1. At least a part of the programming module 300 may be implemented in software, firmware, hardware, or a combination of two or more thereof. The programming module 300 may be implemented in hardware (e.g., the hardware 200), and may include an OS controlling resources related to an electronic device (e.g., the electronic device 100) and/or various applications (e.g., an application 370) executed in the OS. For example, the OS may be Android®, iOS®, Windows®, Symbian®, Tizen®, Bada®, and the like.

Referring to FIG. 3, the programming module 300 may include a kernel 310, a middleware 330, an API 360, and/or the application 370.

The kernel 310 (e.g., the kernel 131) may include a system resource manager 311 and/or a device driver 312. The system resource manager 311 may include, for example, a process manager (not illustrated), a memory manager (not illustrated), and a file system manager (not illustrated). The system resource manager 311 may perform the control, allocation, recovery, and/or the like of system resources. The device driver 312 may include, for example, a display driver (not illustrated), a camera driver (not illustrated), a Bluetooth® driver (not illustrated), a shared memory driver (not illustrated), a USB driver (not illustrated), a keypad driver (not illustrated), a Wi-Fi driver (not illustrated), and/or an audio driver (not illustrated). Also, according to an embodiment of the present disclosure, the device driver 312 may include an Inter-Process Communication (IPC) driver (not illustrated).

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device. For example, as illustrated in FIG. 3, the middleware 330 (e.g., the middleware 132) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager.

The runtime library 335 may include, for example, a library module used by a complier, in order to add a new function by using a programming language during the execution of the application 370. According to an embodiment of the present disclosure, the runtime library 335 may perform functions which are related to input and output, the management of a memory, an arithmetic function, and/or the like.

The application manager 341 may manage, for example, a life cycle of at least one of the applications 370. The window manager 342 may manage GUI resources used on the screen. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370.

The power manager 345 may operate together with a Basic Input/Output System (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connectivity such as, for example, Wi-Fi and Bluetooth. The notification manager 349 may display or report, to the user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. According to an embodiment of the present disclosure, when the electronic device (e.g., the electronic device 100) has a telephone function, the middleware 330 may further include a telephony manager (not illustrated) for managing a voice telephony call function and/or a video telephony call function of the electronic device.

The middleware 330 may generate and use a new middleware module through various functional combinations of the above-described internal element modules. The middleware 330 may provide modules specialized according to types of OSs in order to provide differentiated functions. Also, the middleware 330 may dynamically delete some of the existing elements, or may add new elements. Accordingly, the middleware 330 may omit some of the elements described in the various embodiments of the present disclosure, may further include other elements, or may replace the some of the elements with elements, each of which performs a similar function and has a different name.

The API 360 (e.g., the API 133) is a set of API programming functions, and may be provided with a different configuration according to an OS. In an embodiment of the disclosure including use of an Android® or iOS®, for example, one API set may be provided to each platform. In an embodiment of the disclosure including use of a Tizen®, for example, two or more API sets may be provided to each platform.

The applications 370 (e.g., the applications 134) may include, for example, a preloaded application and/or a third party application. The applications 370 (e.g., the applications 134) may include, for example, a home application 371, a dialer application 372, a Short Message Service (SMS)/Multimedia Message Service (MMS) application 373, an Instant Message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application.

At least a part of the programming module 300 may be implemented by instructions stored in a non-transitory computer-readable storage medium. When the instructions are executed by one or more processors (e.g., the one or more processors 210), the one or more processors may perform functions corresponding to the instructions. The non-transitory computer-readable storage medium may be, for example, the memory 220. At least a part of the programming module 300 may be implemented (e.g., executed) by, for example, the one or more processors 210. At least a part of the programming module 300 may include, for example, a module, a program, a routine, a set of instructions, and/or a process for performing one or more functions.

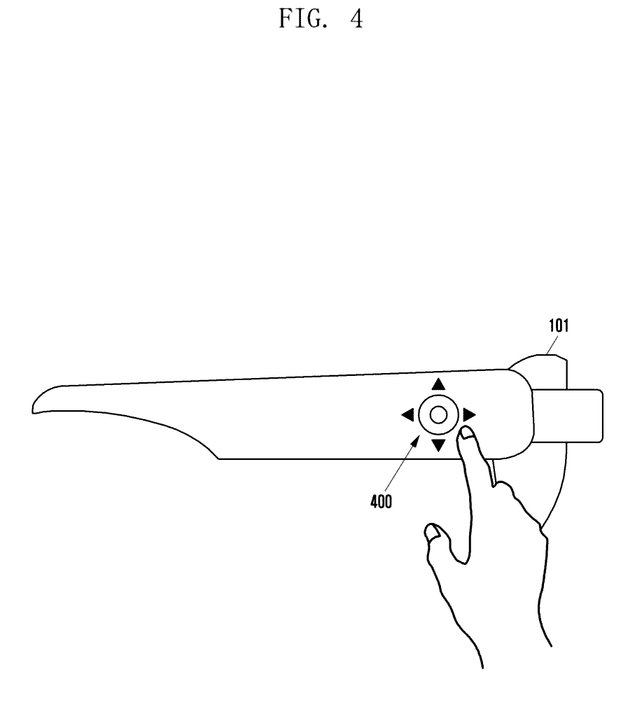

FIG. 4 is a diagram illustrating a side view of an electronic device according to various embodiments of the present disclosure.

According to various embodiments of the present disclosure, the electronic device 101 (e.g., Smart Glass™) is a goggles type that may be attached to a user's facial area. Through this, the residual part, except a lens part, of the electronic device 101 may disallow the travel of light from the outside.

According to various embodiments of the present disclosure, the electronic device 101 may have an external interface 400, attached to a lateral side thereof (e.g., legs of Smart Glass™), for controlling the electronic device 101. For example, the external interface 400 may control the electronic device 101, based on a touch, a button, voice recognition, etc.

According to various embodiments of the present disclosure, if a leftward touch (e.g., swipe back) is received through the external interface 400, a forward function may be executed on the screen of the electronic device 101. If a rightward touch (e.g., swipe forward) is received through the external interface 400, a backward function may be executed on the screen of the electronic device 101.

According to various embodiments of the present disclosure, if a downward touch (e.g., swipe) is received through the external interface 400, a hidden menu may appear on the display.

According to various embodiments of the present disclosure, the external interface 400 may have a central button for receiving a user's tap or multi-tap action to perform a predetermined specific function. For example, the electronic device 101 may invoke a basic menu in response to a double tap on the external interface 400.

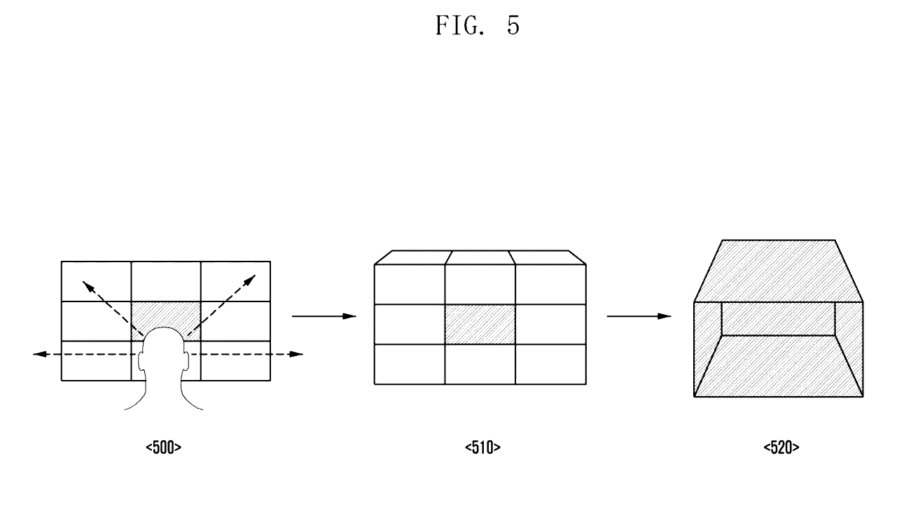

FIG. 5 is a diagram illustrating a menu access method of the electronic device according to various embodiments of the present disclosure.

According to various embodiments of the present disclosure, the electronic device 101 may display a menu screen including at least one object to a user as indicated by a reference number 500. The electronic device 101 may detect a user's head movement and then, based on upward, downward, leftward, and rightward head movements, output different menu screens.

According to various embodiments of the present disclosure, the electronic device 101 may track a user's eye gaze and thereby, as indicated by a reference number 510, identify a specific object to be executed in response to a user's intention.

According to various embodiments of the present disclosure, the electronic device 101 may detect a user input through the external interface 400 and then, as indicated by a reference number 520, execute a specific object selected in response to the detected user input. For example, the electronic device 101 may detect a user's touch (e.g., swipe back), tap or voice input and then execute a specific object to which a user's eye gaze is fixed when such an input is detected.

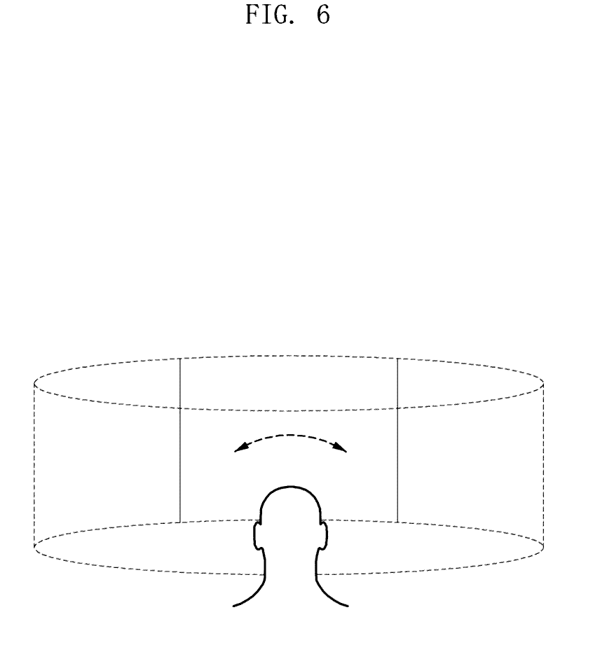

FIG. 6 is a diagram illustrating a rotation of an electronic device according to various embodiments of the present disclosure.

According to various embodiments of the present disclosure, the electronic device 101 may detect a user's 360-degree rotation and output different screens in response to the detected rotation. For example, the electronic device 101 may output different menus or contents in response to an angle of a user's rotation.

According to various embodiments of the present disclosure, the electronic device 101 may output different screens that includes different viewpoints of the same content in response to an angle of a user's rotation. For example, when executing a panorama function, the electronic device 101 may provide a view as if a user actually rotates 360 degrees at the top of the mountain.

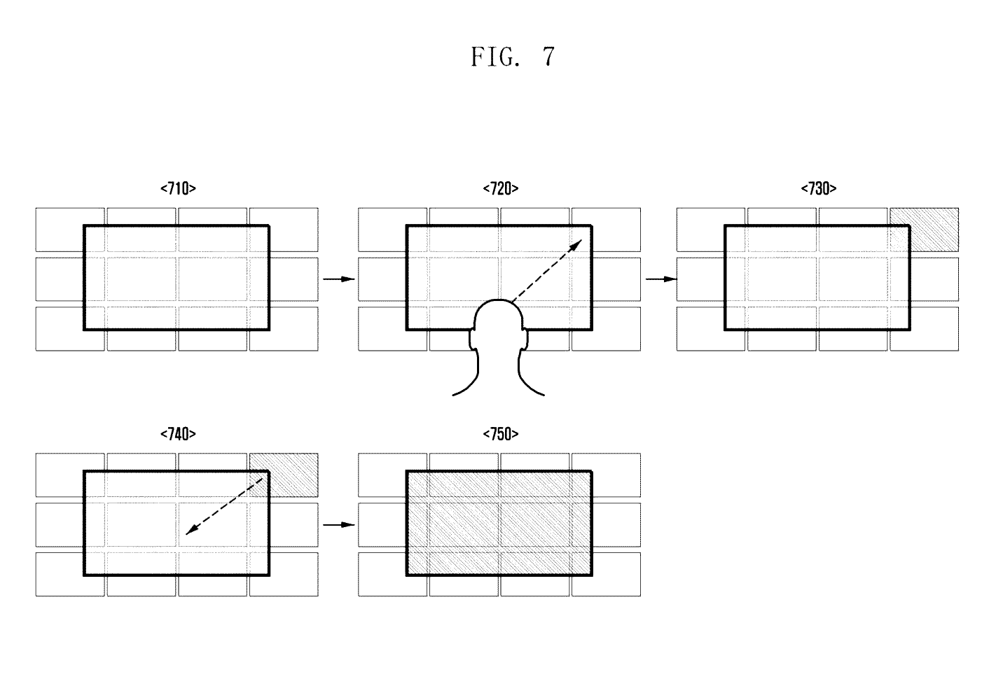

FIG. 7 illustrates a method for changing objects by selecting one of objects in an electronic device according to various embodiments of the present disclosure.

According to various embodiments of the present disclosure, at operation 710, the electronic device 101 may display a currently executed object together with a menu including a plurality of objects. For example, the electronic device 101 may display a currently executed object to overlap with a menu screen including a plurality of objects.

According to various embodiments of the present disclosure, at operation 720, the electronic device 101 may detect a user's eye gaze.

According to various embodiments of the present disclosure, at operation 730, the electronic device 101 may highlight a specific object to which a user's eye gaze is fixed. For example, the electronic device 101 may change a color tone or shade of such a specific object or offer a preview of the specific object.

According to various embodiments of the present disclosure, at operation 740, the electronic device 101 may receive a user's input for selecting the specific object to which a user's eye gaze is fixed. For example, the electronic device 101 may detect a touch action (e.g., swipe back) on the external interface 400, a tap action on the button, or a voice input corresponding to an execution request.

According to various embodiments of the present disclosure, at operation 750, the electronic device 101 may display the specific object selected by a user instead of a currently executed object. For example, the electronic device 101 may display the selected object at the center of the display in an enlarged form.

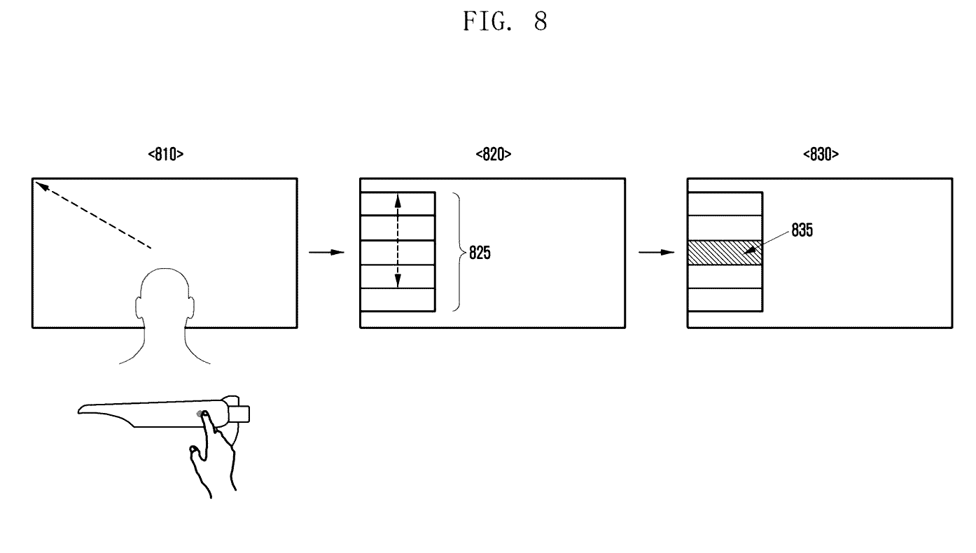

FIG. 8 is a diagram illustrating a non-linear object search method of an electronic device according to various embodiments of the present disclosure.

According to various embodiments of the present disclosure, at operation 810, the electronic device 101 may detect a user's eye gaze focused on a predetermined position (e.g., a left upper corner) for a predetermined time. Further, according to various embodiments of the present disclosure, at operation 810, the electronic device 101 may detect a user's tap or touch action on the button of the external interface 400 while a user's eye gaze is fixed to a predetermined position (e.g., a left upper corner). Meanwhile, the predetermined position may be set or changed by a user or a manufacturer.

According to various embodiments of the present disclosure, at operation 820, the electronic device 101 may output a hidden menu 825 in response to the detection at the operation 810. For example, the hidden menu 825 may have predetermined objects (e.g., applications, contents, services, etc.), and such objects may be arranged in the order of user's higher preference.

According to various embodiments of the present disclosure, at operation 820, the electronic device 101 may highlight a specific object to which a user's eye gaze is fixed. Alternatively or additionally, according to various embodiments of the present disclosure, at operation 820, the electronic device 101 may detect a user's head motion and then highlight a specific object to which a user's head is facing. For example, the electronic device 101 may change a color tone or shade of such a specific object or offer a preview of the specific object.

According to various embodiments of the present disclosure, at operation 830, the electronic device 101 may receive a user's input for selecting a specific object 835 to which a user's eye gaze is fixed or to which a user's head faces. For example, the electronic device 101 may detect a touch action (e.g., swipe back) on the external interface 400, a tap action on the button, or a voice input corresponding to an execution request. Then, the electronic 101 may execute the object 835 selected by a user.

Therefore, the electronic device 101 according to various embodiments of the present disclosure may activate the hidden menu by using the above-discussed non-linear object search method, as shown in FIG. 8, without a need to sequentially move to a home menu through repeated backwards, and thereby easily perform a particular function desired by a user.

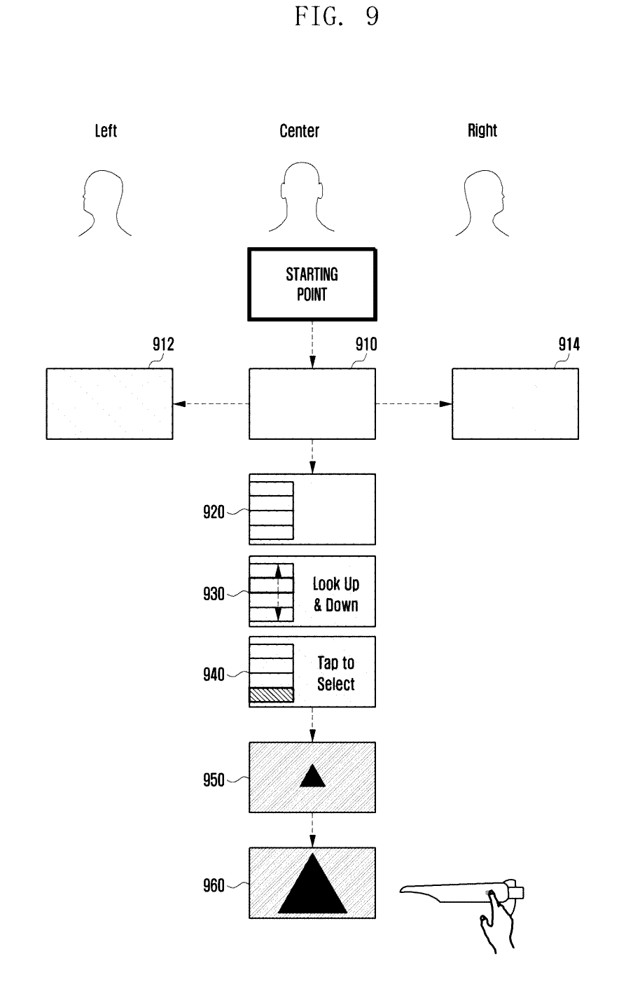

FIG. 9 is a diagram illustrating a method for executing at least one object in an electronic device according to various embodiments of the present disclosure.

According to various embodiments of the present disclosure, at operation 910, the electronic device 101 may display a certain screen.

According to various embodiments of the present disclosure, if a user's head faces leftward, the electronic device 101 may execute at operation 912 a predetermined object (application, content, service, etc.) corresponding to the left direction.

According to various embodiments of the present disclosure, if a user's head faces rightward, the electronic device 101 may execute at operation 914 a predetermined object (application, content, service, etc.) corresponding to the right direction.

According to various embodiments of the present disclosure, at operation 920, the electronic device 101 may activate a hidden menu when a user's eye gaze is fixed to a predetermined position for a predetermined time. According to another embodiment of the present disclosure, at operation 920, the electronic device 101 may activate the hidden menu when a separate execution input (e.g., touch, tap, voice input) is received while a user's eye gaze stays at the predetermined position.

According to various embodiments of the present disclosure, at operation 930, the electronic device 101 may detect a movement of a user's eye gaze or head and thereby scroll at least one object arranged in the activated menu.

According to various embodiments of the present disclosure, at operation 930, the electronic device 101 may highlight a currently scrolled object to distinguish it from other objects. For example, a specific object, to which a user's eye gaze or head is fixed or facing, may be displayed differently from other objects in a color tone, a shade, a size, or the like.

According to various embodiments of the present disclosure, at operation 940, the electronic device 101 may receive a user's input for selecting a specific object to which a user's eye gaze or head is fixed or facing. For example, the electronic device 101 may detect a touch action on the external interface 400 (e.g., swipe back), a tap action on the button, or a voice input corresponding to an execution request.

According to various embodiments of the present disclosure, at operation 950, the electronic device 101 may execute and display the object (application, content, service, etc.) selected by a user.

According to various embodiments of the present disclosure, at operation 960, the electronic device 101 may enlarge the executed and displayed object (application, content, service, etc.) in response to a user input. For example, the electronic device 101 may enlarge the object in the response to a user's touch (e.g., swipe back) so as to help a user to be immersed in the object being executed.

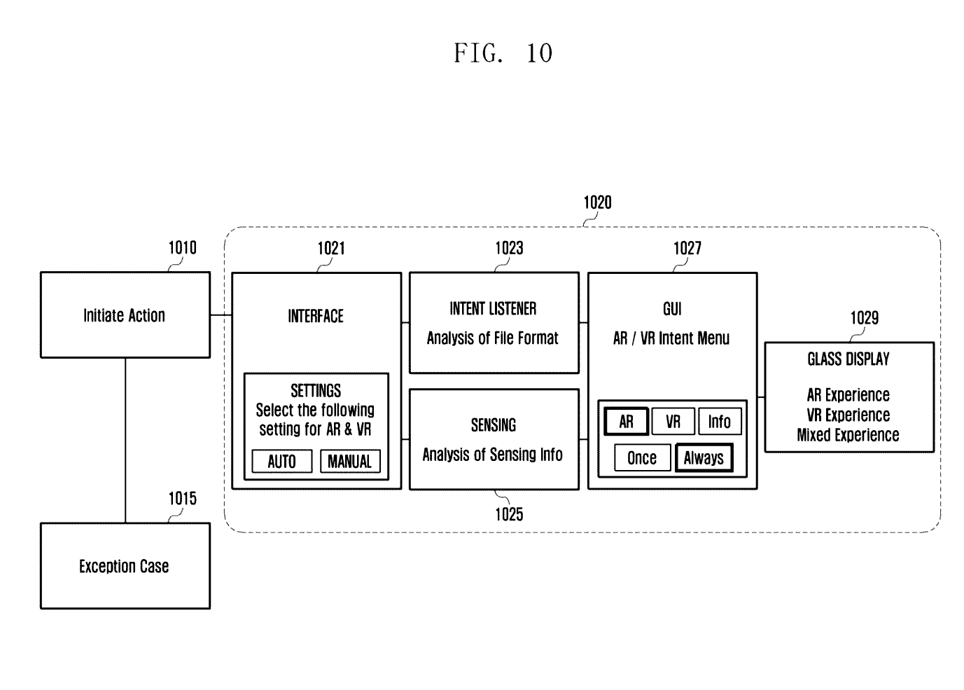

FIG. 10 is a diagram illustrating a user interface for setting one of AR and VR in an electronic device according to various embodiments of the present disclosure.

According to various embodiments of the present disclosure, the electronic device 101 may provide a user interface 1021 and/or 1027 to be used for setting AR and/or VR.

According to various embodiments of the present disclosure, the electronic device 101 may detect a user's initiate action 1010. For example, the electronic device 101 may regard, as the initiate action 1010, a user's action to wear the electronic device (e.g., smart glass). Alternatively or additionally, the electronic device 101 may regard a predetermined gesture or voice command as the initiate action 1010. Further, the electronic device 101 may regard a user's action for executing the object (application, content, service, etc.) as the initiate action 1010.

According to various embodiments of the present disclosure, even though detecting the initiate action 1010, in an exception case 1015, the electronic device 101 may operate with a setting value corresponding to the exception case 1015 rather than outputting the user interface 1021 and/or 1027. For example, if a certain exception case 1015 such as a user's driving is detected, the electronic device 101 may keep a display transparency without any change thereof. If the display transparency is kept to be dark in driving, the risk of accident may rise due to a driver's poor visibility.

According to various embodiments of the present disclosure, in response to the initiate action 1010, the electronic device 101 may enter the interface 1021 for setting automatically or manually AR or VR.

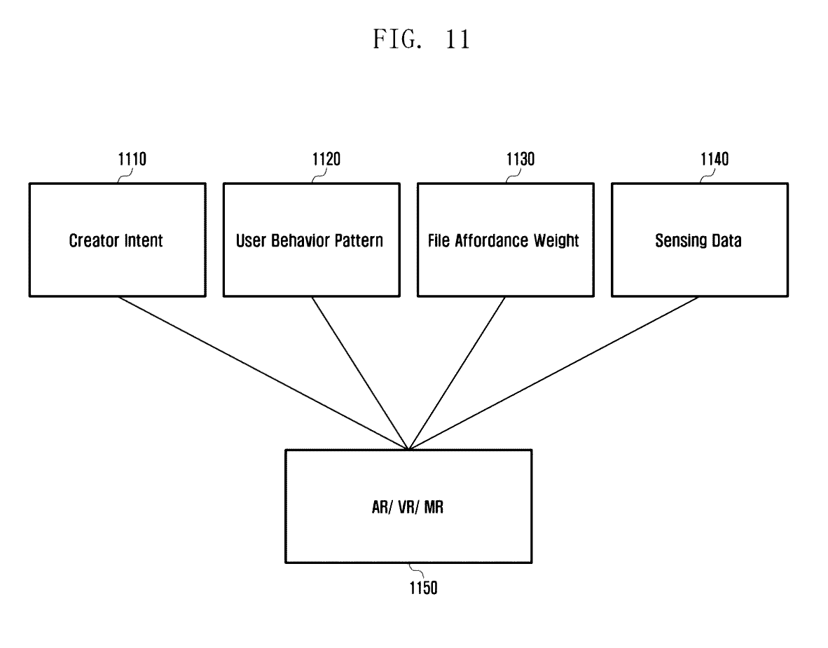

According to various embodiments of the present disclosure, if a user input for selecting an auto option on the interface 1021 is received, the electronic device 101 may recommend, based on a reference factor (e.g., a file format 1023, sensing information 1025, etc.), an optimal mode for a specific object to be executed. For example, the electronic device 101 may highlight a recommended item (e.g., AR, Always) on the interface 1027. Meanwhile, the reference factor 1023, 1025, or the like will be described below with reference to FIG. 11.

According to various embodiments of the present disclosure, if a user input for selecting a manual option on the interface 1021 is received, the electronic device 101 may move to the interface 1027 and then, without any highlighted display, receive an input for selecting a display mode (AR, VR, info.), a duration type (Once, Always), and the like.

As indicated by a reference number 1029, the electronic device 101 may provide a mixed reality (MR) in addition to AR and VR. According to various embodiments of the present disclosure, the electronic device 101 may adjust the transparency of display and then provide AR, VR, or MR. For example, when the electronic device 101 adjusts the transparency of display and then provides an AR, the electronic device 101 may adjust the transparency of display to 100% so as to pass the light from the outside. When a VR is provided, the electronic device 101 may adjust the transparency of display to 0% so as to block the light from the outside. Meanwhile, when a MR is provided, the electronic device 101 may adjust the transparency of display to any value greater than 0% and smaller than 100% and then output an object (application, content, service, etc). Thus, the electronic device 101 may provide an option for selecting VR on the interface 1027 and also provide an option for selecting a desired transparency. Further, the electronic device 101 may analyze an object (application, content, service, etc.) to be executed and thereby automatically recommend VR or recommend a suitable transparency.

According to various embodiments of the present disclosure, while any object (application, content, service, etc.) is being executed, the electronic device 101 may activate the interface 1027 in response to a user input (e.g., a gaze analysis, a touch input, a tap input, a voice input, etc.) and change an output mode by selecting AR, VR or MR.

FIG. 11 is a diagram illustrating reference factors considered for selecting one of AR, VR, and MR by an electronic device according to various embodiments of the present disclosure.

According to various embodiments of the present disclosure, the electronic device 101 may provide an optimal display mode 1150 to a user, based on at least one reference factor. For example, based on at least one of a creator intent 1110, a user behavior pattern 1120, a file format (also referred to as a file affordance weight) 1130, and a sensing data 1140, the electronic device 101 may provide the optimal display mode 1150 (AR/VR/MR) optimized for an object to be executed.

According to various embodiments of the present disclosure, the electronic device 101 may determine the display mode 1150, based on the creator intent 1110. Here, a creator may refer to a producer of an object (e.g., application, content, service, etc.) or an object provider. The electronic device 101 may determine the display mode 1150, based on a screen organization scheme predefined by a producer or a provider.

According to various embodiments of the present disclosure, the electronic device 101 may determine the display mode 1150, based on the user behavior pattern 1120. For example, the electronic device 101 may analyze a display mode usage pattern about an object to be executed. If a specific display mode has been used more than a given rate, the electronic device 101 may recommend the specific display mode to a user or automatically execute the specific display mode.

According to various embodiments of the present disclosure, the electronic device 101 may determine the display mode 1150, based on the file format 1130. The electronic device 101 may analyze the file format of an object to be executed and then determine the display mode 1150 based on a screen organization scheme generally applied to the analyzed file format. For example, if a user desires to execute a 3D game, the electronic device 101 may execute a VR display mode generally applied to a 3D game.

According to various embodiments of the present disclosure, the electronic device 101 may determine the display mode 1150, based on the sensing information 1140. Using at least one of the communication module 220 and the sensor module 240, the electronic device 101 may analyze a user position, an external environment of a user, and the like. For example, the electronic device 101 may recognize a user's driving state by using a short range wireless communication with a vehicle, and in this example, stop the operation of the VR display mode.

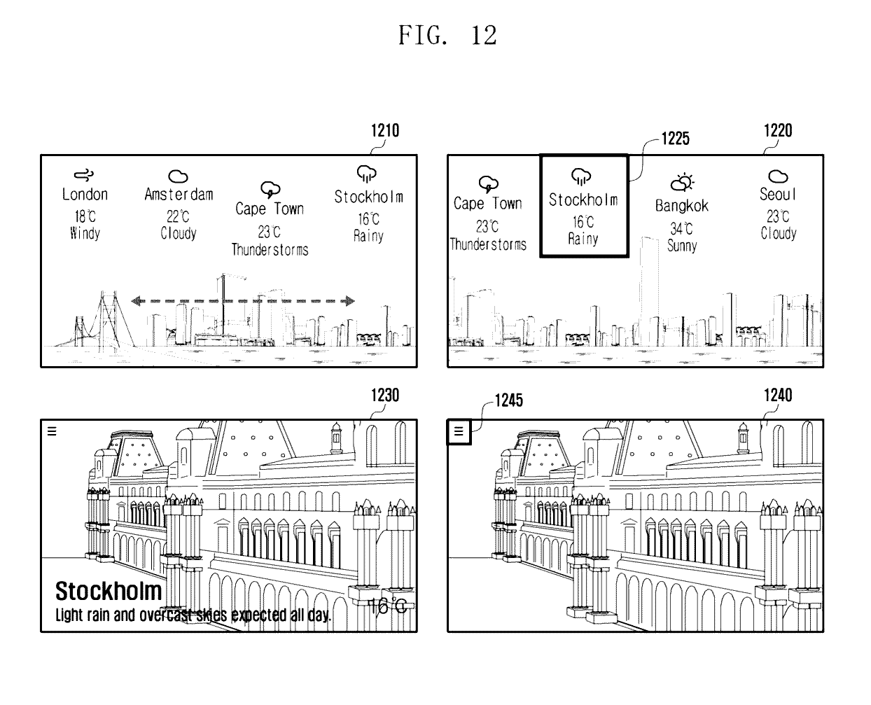

FIG. 12 is a diagram illustrating a method for providing weather information in an electronic device according to various embodiments of the present disclosure.

According to various embodiments of the present disclosure, the electronic device 101 may execute a weather application in response to the initiate action 1010.

According to various embodiments of the present disclosure, the electronic device 101 may recognize the form of weather content (e.g., a text or emoticon form) and then select the AR display mode. Thus, the electronic device 101 may set the transparency of display to 100%.

According to various embodiments of the present disclosure, the electronic device 101 may output weather information about a user's current position in the AR display mode by using the GPS module 227.

According to various embodiments of the present disclosure, the electronic device 101 may track a user's head and then change AR information. For example, if a user turns his or her head rightward in screenshot 1210, the electronic device 101 may display screenshot 1220 to display changed AR information. As shown in screenshot 1220, weather information about Seoul newly appears as AR information. Meanwhile, the electronic device 101 may display a city or country as AR information and selectively display a specific city or country marked as favorites by a user.

According to various embodiments of the present disclosure, the electronic device 101 may scroll AR information on the display through eye tracking. According to various embodiments of the present disclosure, the electronic device 101 may highlight specific AR information 1125 to which a user's eye gaze is fixed. For example, the electronic device 101 may give a particular effect (e.g., a rainy animation of a weather emoticon) to such specific AR information where a user's eye gaze stays.

According to various embodiments of the present disclosure, in response to a user input (e.g., eye analysis, touch input, tap input, voice input, gesture input, etc.), the electronic device 101 may display detailed weather information about a city to which a user's eye gaze is fixed.

According to various embodiments of the present disclosure, the electronic device 101 may recognize the format of weather content (e.g., media content) of a city selected by a user in the detailed weather information 1230 or 1240 and then select a VR display mode. Thus, the electronic device 101 may set the transparency of display to 0%. Through this, a user of the electronic device 101 may experience immersive weather information as if he or she is in the selected city.

According to various embodiments of the present disclosure, the electronic device 101 may detect a user's eye gaze which is facing to a predetermined position 1245 for a predetermined time. Also, according to various embodiments of the present disclosure, the electronic device 101 may detect a user's tap or touch action on the external interface 400 with a user's eye gazing at the predetermined position 1245, and then display a hidden menu. Meanwhile, the predetermined position may be set or changed by a user or a manufacturer.

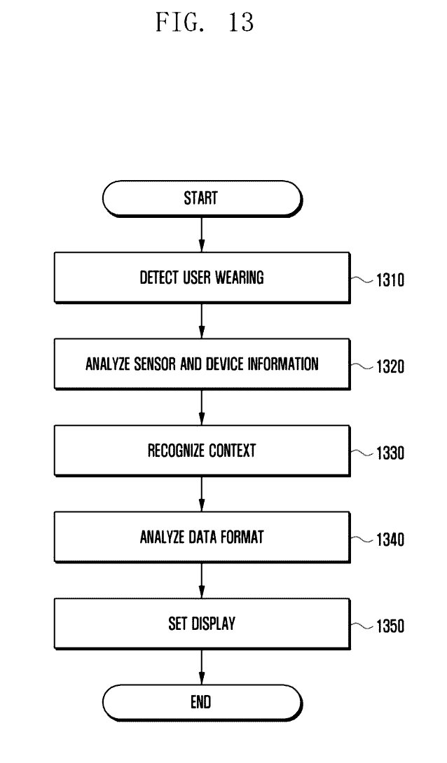

FIG. 13 is a flow diagram illustrating a method for setting a display mode depending on a context analysis in an electronic device according to various embodiments of the present disclosure.

According to various embodiments of the present disclosure, at operation 1310, the electronic device 101 may detect a user wearing the electronic device 101.

According to various embodiments of the present disclosure, at operation 1320, the electronic device 101 may analyze sensor and device information. For example, using the GPS module 227, the electronic device 101 may recognize that a user is at home. Further, the electronic device 101 may analyze an alarm or schedule application set in the electronic device 101.

According to various embodiments of the present disclosure, at operation 1330, the electronic device 101 may recognize a user's current context, based on the information analyzed at operation 1320. For example, based on the analysis at operation 1320, the electronic device 101 may recognize that a user's wake-up time is set at 8 o'clock and also a business meeting is scheduled at 10 in the morning.

According to various embodiments of the present disclosure, at operation 1340, the electronic device 101 may analyze the format of data to be offered to a user. For example, if information to be offered to a user is about a schedule, the electronic device 101 may determine such information to be offered using text or emoticon.

According to various embodiments of the present disclosure, at operation 1350, the electronic device 101 may select a display mode. Namely, based on the above-discussed operations 1310 to 1340, the electronic device 10 may select the most suitable display mode among AR, VR, and MR display modes. For example, if it is analyzed at operations 1310 to 1340 that a user is currently at home and a business meeting is scheduled at 10 in the morning, the electronic device 101 may display a user's schedule as AR information using text or emoticon.

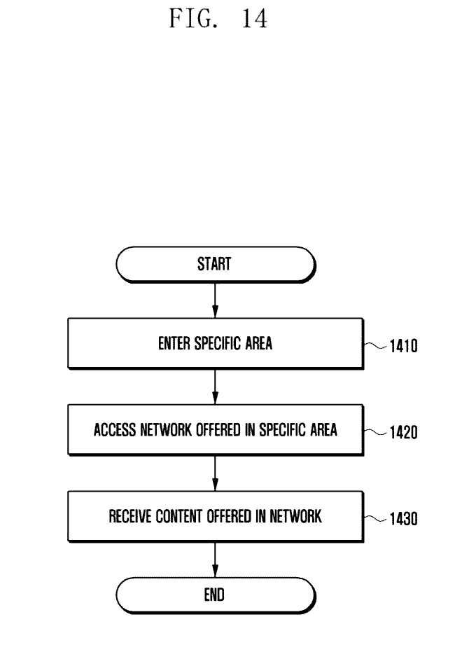

FIG. 14 is a flow diagram illustrating a method for receiving an object provided in a specific area by an electronic device according to various embodiments of the present disclosure.

According to various embodiments of the present disclosure, at operation 1410, the electronic device 101 may ascertain that a user enters a specific area. For example, using the communication module 220, the electronic device 101 may ascertain that a user enters a security area.

According to various embodiments of the present disclosure, at operation 1420, the electronic device 101 may access a network offered in the specific area. For example, the electronic device 101 may communicate with a network offered in a security area.

According to various embodiments of the present disclosure, at operation 1430, the electronic device 101 may receive an object (e.g., application, content, service, etc.) offered by the accessed network. For example, the electronic device 101 may operate in a security mode offered in a security area and also, by the security mode, be restricted in using various functions of the electronic device 101.

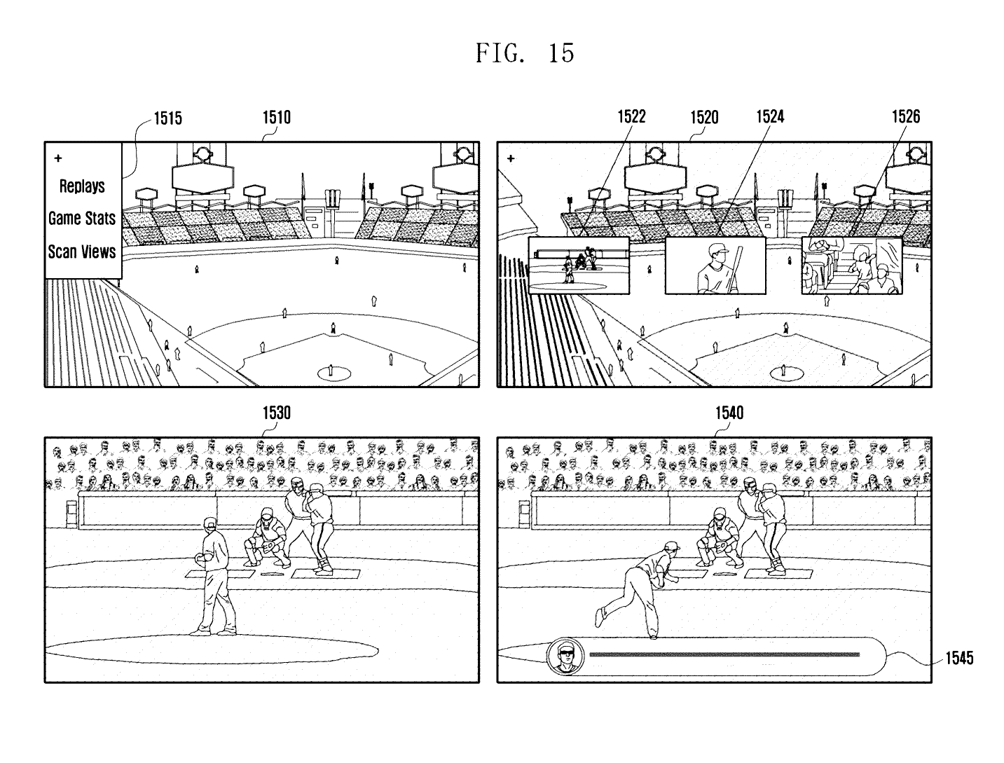

FIG. 15 is a diagram illustrating a method for outputting an object provided in a specific area by an electronic device according to various embodiments of the present disclosure.

According to various embodiments of the present disclosure, using the communication module 220, the electronic device 101 may ascertain that a user is located in a specific area (e.g., a baseball stadium).

According to various embodiments of the present disclosure, as shown in screenshot 1510, the electronic device 101 may access a network provided in the specific area (e.g., a baseball stadium) by using the communication module 220 and also receive an object 1515 offered in the network. For example, the electronic device 101 may receive replays, game stats, scan views, and the like from the network of the baseball stadium.

According to various embodiments of the present disclosure, as shown in screenshot 1510, the electronic device 101 may analyze the format of the object 1515 offered in the network and, based on this analysis, select a display mode. For example, since the object 1515 is text data, the electronic device 101 may display the object 1515 in the AR display mode and also set the transparency of display to 100%.

According to various embodiments of the present disclosure, the electronic device 101 may receive a user input for selecting a scan view. For example, the electronic device 101 may receive a voice command to execute a scan view, detect a user's eye gaze fixed to a scan view for a given time, or receive a user's touch or tap action on the external interface 400 with a user's eye gazing at a scan view.

According to various embodiments of the present disclosure, as shown in screenshot 1520, the electronic device 101 may display at least one scan view 1522, 1524, and/or 1526. The electronic device 101 may browse other scan views, currently not shown on the display, in response to a user's head tracking. For example, the electronic device 101 may browse non-displayed scan views other than the scan views 1522, 1524 and 1526 in response to head tracking.

According to various embodiments of the present disclosure, as shown in screenshot 1520, the electronic device 101 may select one of the displayed scan views 1522, 1524 and 1526. For example, the electronic device 101 may select and execute a specific scan view when receiving a corresponding voice command, detecting a user's eye gaze fixed to a specific scan view, or receiving a user's touch or tap action on the external interface 400 with a user's eye gazing at a specific scan view. For example, in response to a user input for selecting the scan view 1522, the electronic device 101 may enlarge the selected scan view 1522 on the display.

According to various embodiments of the present disclosure, as shown in screenshot 1520, the electronic device 101 may use the MR display mode in displaying the scan views 1522, 1524 and 1526. For example, the electronic device 101 may adjust the transparency of display to 50% and also display the scan views 1522, 1524 and 1526, which are VR contents, differently from a normal background (e.g., a scene which is seen by a user at a current position).

According to various embodiments of the present disclosure, as shown in screenshot 1530, the electronic device 101 may enlarge the specific scan view selected by a user and then display the enlarged scan view at the center of the display. For example, the electronic device 101 may enlarge and display VR content corresponding to the scan view 1522 at the center of the display.

According to various embodiments of the present disclosure, as shown in screenshot 1530, the electronic device 101 may display the selected scan view 1522 by means of an immersive image using the VR display mode. For example, the electronic device 101 may adjust the transparency of display to 0% and then display VR content.

According to various embodiments of the present disclosure, as shown in screenshot 1540, the electronic device 101 may share a viewpoint with another user who is located at a specific area (e.g., a baseball stadium). For example, the electronic device 101 may transmit an image captured at a user's viewpoint to users of other electronic devices 102 and 104 who are located in the baseball stadium. Through this, a user of the electronic device 101 may vividly appreciate various images of different viewpoints without limitations in his or her position.

According to various embodiments of the present disclosure, the electronic device 101 may display, on the display, a request 1545 for inquiring about whether to receive images obtained by other electronic device 102 and 104 from other users or whether to transmit an image obtained by the electronic device 101 to other users.

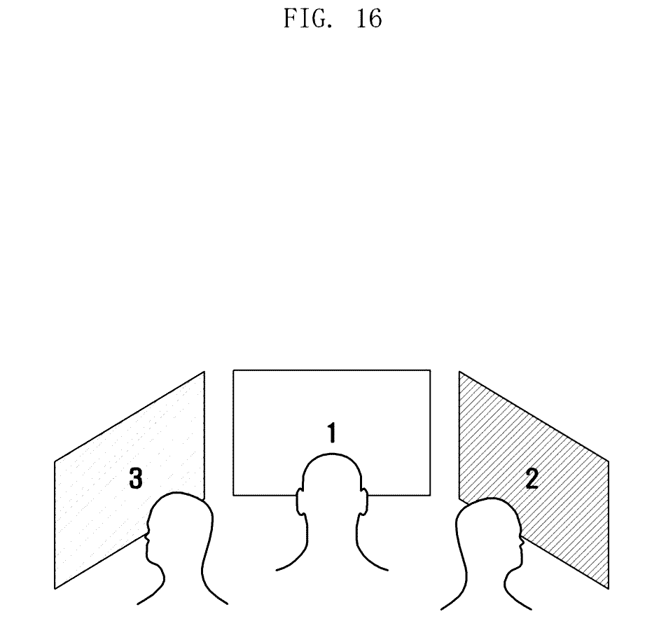

FIG. 16 is a diagram illustrating a method for outputting different objects based on a head rotation of a user of an electronic device according to various embodiments of the present disclosure.

According to various embodiments of the present disclosure, the electronic device 101 may detect a user's head tracking and, based on the detected head tracking, display different objects (e.g., applications, contents, services, etc.) or different screens (e.g., a panorama view) from different viewpoints of the same object.

According to various embodiments of the present disclosure, the electronic device 101 may display first, second and third objects depending on the head tracking and then execute different display modes based on the reference factor (e.g., creator intent, file format, user behavior pattern, sensing data, etc.) of the corresponding object.

According to various embodiments, a method for outputting content in an electronic device may include operations of detecting a selection of content by a user; ascertaining a reference factor corresponding to the content; determining a display mode corresponding to the reference factor; and outputting the content, based on the display mode.

The operation of detecting the selection of content may include tracking a user's eye gaze and thereby identifying the content to which the eye gaze is facing; and if the eye gaze is fixed to the content for a predetermined time, determining that the content is selected.

The operation of detecting the selection of content may include tracking a user's eye gaze and thereby identifying the content to which the eye gaze is facing; and by receiving a user input while the eye gaze is fixed to the content, determining that the content is selected.

The user input may include a touch action, a tap action, a swipe action, or a voice input.

The reference factor may include at least one of a content creator intent, a user behavior pattern, a content file format, and external environment information.

The external environment information may include at least one of user position information and electronic device sensor information.

The display mode may include an augmented reality (AR) mode, a virtual reality (VR) mode, and a mixed reality (MR) mode.

The operation of outputting the content may include outputting the content by adjusting a display transparency of the electronic device to 100% in the AR mode.

The operation of outputting the content may include outputting the content by adjusting a display transparency of the electronic device to 0% in the VR mode.

The operation of outputting the content may include outputting the content by adjusting a display transparency of the electronic device to a value greater than 0% and smaller than 100% in the MR mode.

According to various embodiments, an electronic device may include a display; a communication module; a sensor module; a processor electrically connected to the display, the communication module, and the sensor module; and a memory electrically connected to the processor. The memory may store instructions which cause, when executed, the processor to detect a selection of content by a user, to ascertain a reference factor corresponding to the content, to determine a display mode corresponding to the reference factor, and to output the content, based on the display mode.

The instructions may cause the processor, when detecting the selection of content, to track a user's eye gaze, to thereby identify the content to which the eye gaze is facing, and if the eye gaze is fixed to the content for a predetermined time, to determine that the content is selected.

The instructions may cause the processor, when detecting the selection of content, to track a user's eye gaze, to thereby identify the content to which the eye gaze is facing, and by receiving a user input while the eye gaze is fixed to the content, to determine that the content is selected.

The user input may include a touch action, a tap action, a swipe action, or a voice input.

The reference factor may include at least one of a content creator intent, a user behavior pattern, a content file format, and external environment information.

The external environment information may include at least one of user position information and electronic device sensor information.

The display mode may include an augmented reality (AR) mode, a virtual reality (VR) mode, and a mixed reality (MR) mode.

The instructions may cause the processor to output the content by adjusting a display transparency of the electronic device to 100% in the AR mode.

The instructions may cause the processor to output the content by adjusting a display transparency of the electronic device to 0% in the VR mode.

The instructions may cause the processor to output the content by adjusting a display transparency of the electronic device to a value greater than 0% and smaller than 100% in the MR mode.

The term “module” used in the present disclosure may refer to, for example, a unit including one or more combinations of hardware, software, and firmware. The “module” may be interchangeable with a term, such as “unit,” “logic,” “logical block,” “component,” “circuit,” or the like. The “module” may be a minimum unit of a component formed as one body or a part thereof. The “module” may be a minimum unit for performing one or more functions or a part thereof. The “module” may be implemented mechanically or electronically. For example, the “module” according to an embodiment of the present disclosure may include at least one of an Application-Specific Integrated Circuit (ASIC) chip, a Field-Programmable Gate Array (FPGA), and a programmable-logic device for performing certain operations which have been known or are to be developed in the future.

Examples of computer-readable media include: magnetic media, such as hard disks, floppy disks, and magnetic tape; optical media such as Compact Disc Read Only Memory (CD-ROM) disks and Digital Versatile Disc (DVD); magneto-optical media, such as floptical disks; and hardware devices that are specially configured to store and perform program instructions (e.g., programming modules), such as read-only memory (ROM), random access memory (RAM), flash memory, etc. Examples of program instructions include machine code instructions created by assembly languages, such as a compiler, and code instructions created by a high-level programming language executable in computers using an interpreter, etc. The described hardware devices may be configured to act as one or more software modules in order to perform the operations and methods described above, or vice versa.

Modules or programming modules according to the embodiments of the present disclosure may include one or more components, remove part of them described above, or include new components. The operations performed by modules, programming modules, or the other components, according to the present disclosure, may be executed in serial, parallel, repetitive or heuristic fashion. Part of the operations can be executed in any other order, skipped, or executed with additional operations.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for outputting content in an electronic device, the method comprising operations of:
detecting a content selected by a user;
ascertaining a reference factor corresponding to the content;
determining a display mode corresponding to the reference factor; and
outputting the content, based on the display mode.

2. The method of claim 1, wherein the operation of detecting the content selected by the user includes:
tracking a user's eye gaze and thereby identifying the content to which the eye gaze is facing; and
in response to the eye gaze being fixed to the content for a predetermined time, determining that the content is selected.

3. The method of claim 1, wherein the operation of detecting the content selected by the user includes:
tracking a user's eye gaze and thereby identifying the content to which the eye gaze is facing; and
in response to receiving a user input while the eye gaze is fixed to the content, determining that the content is selected.

4. The method of claim 3, wherein the user input includes a touch action, a tap action, a swipe action, or a voice input.

5. The method of claim 1, wherein the reference factor includes at least one of a content creator intent, a user behavior pattern, a content file format, and external environment information.

6. The method of claim 5, wherein the external environment information includes at least one of user position information and electronic device sensor information.

7. The method of claim 1, wherein the display mode includes an augmented reality (AR) mode, a virtual reality (VR) mode, and a mixed reality (MR) mode.

8. The method of claim 7, wherein the operation of outputting the content includes outputting the content by adjusting a display transparency of the electronic device to 100% in the AR mode.

9. The method of claim 7, wherein the operation of outputting the content includes outputting the content by adjusting a display transparency of the electronic device to 0% in the VR mode.

10. The method of claim 7, wherein the operation of outputting the content includes outputting the content by adjusting a display transparency of the electronic device to a value greater than 0% and smaller than 100% in the MR mode.

11. An electronic device comprising:
a display;
a communication module;
a sensor module;
a processor electrically connected to the display, the communication module, and the sensor module; and
a memory electrically connected to the processor,
wherein the memory stores instructions which, when executed, cause the processor to:
detect a content selected by a user;
ascertain a reference factor corresponding to the content;
determine a display mode corresponding to the reference factor; and
output the content, based on the display mode.

12. The electronic device of claim 11, wherein the instructions, when executed, cause the processor to detect the content selected by the user, by further causing the processor to:
track a user's eye gaze, to thereby identify the content to which the eye gaze is facing; and
in response to the eye gaze being fixed to the content for a predetermined time, to determine that the content is selected.

13. The electronic device of claim 11, wherein the instructions, when executed, cause the processor to detect the content selected by the user, by further causing the processor to:
track a user's eye gaze, to thereby identify the content to which the eye gaze is facing; and
in response to receiving a user input while the eye gaze is fixed to the content, to determine that the content is selected.

14. The electronic device of claim 13, wherein the user input includes a touch action, a tap action, a swipe action, or a voice input.

15. The electronic device of claim 11, wherein the reference factor includes at least one of a content creator intent, a user behavior pattern, a content file format, and external environment information.

16. The electronic device of claim 15, wherein the external environment information includes at least one of user position information and electronic device sensor information.

17. The electronic device of claim 11, wherein the display mode includes an augmented reality (AR) mode, a virtual reality (VR) mode, and a mixed reality (MR) mode.

18. The electronic device of claim 17, wherein the instructions cause the processor to output the content by adjusting a display transparency of the electronic device to 100% in the AR mode.

19. The electronic device of claim 17, wherein the instructions cause the processor to output the content by adjusting a display transparency of the electronic device to 0% in the VR mode.

20. The electronic device of claim 17, wherein the instructions cause the processor to output the content by adjusting a display transparency of the electronic device to a value greater than 0% and smaller than 100% in the MR mode.
